(19) United States
(12) Patent Application Publication
(10) Pub. No.: US 2019/0067747 A1
(43) Pub. Date: Feb. 28, 2019

(54) AQUEOUS ELECTROLYTE SOLUTION AND AQUEOUS LITHIUM ION SECONDARY BATTERY

(71) Applicant: TOYOTA JIDOSHA KABUSHIKI KAISHA, Toyota-shi (JP)

(72) Inventors: Hideki NAKAYAMA, Susono-shi (JP); Hiroshi SUYAMA, Mishima-shi (JP)

(73) Assignee: TOYOTA JIDOSHA KABUSHIKI KAISHA, Toyota-shi (JP)

(21) Appl. No.: 16/035,787

(22) Filed: Jul. 16, 2018

(30) Foreign Application Priority Data
Aug. 30, 2017 (JP) 2017-166120

(51) Int. Cl. H01M 10/38; H01M 4/485; H01M 4/505; H01M 4/62; H01M 4/66; H01M 2/16; C25C 3/02

(52) U.S. Cl. CPC H01M 10/38; H01M 4/485; H01M 4/505; H01M 4/621; H01M 2004/027; H01M 2/1626; C25C 3/02; H01M 2300/0002; H01M 4/661

(57) ABSTRACT

Disclosed is an aqueous electrolyte solution that is difficult to be reduced to be decomposed, and that can improve properties of a lithium ion secondary battery when the solution is applied to the battery. The aqueous electrolyte solution for a lithium ion secondary battery includes: water; a lithium ion; a TFSI anion; and a cation that can form an ionic liquid when the cation forms a salt along with the TSFI anion in an atmospheric atmosphere, the cation being at least one selected from the group consisting of an ammonium cation, a piperidinium cation, a phosphonium cation, and an imidazolium cation.

### FIELD

The present application discloses an aqueous electrolyte solution used for a lithium ion secondary battery etc.

### BACKGROUND

A lithium ion secondary battery that contains a flammable nonaqueous electrolyte solution is equipped with a lot of members for safety measures, and as a result, an energy density per volume as a whole of the battery becomes low, which is problematic. In contrast, a lithium ion secondary battery that contains a nonflammable aqueous electrolyte solution does not need safety measures as described above, and thus has various advantages such as a high energy density per volume (Patent Literatures 1, 2, etc.). However, a conventional aqueous electrolyte solution has a problem of a narrow potential window, which restricts active materials etc. that can be used.

As one means for solving the above described problem that the aqueous electrolyte solution has, Non Patent Literature 1 discloses that a high concentration of lithium bis(trifluoromethanesulfonyl)imide (hereinafter may be referred to as “LiTFSI”) is dissolved in an aqueous electrolyte solution, to expand the range of a potential window of the aqueous electrolyte solution. In Non Patent Literature 1, such an aqueous electrolyte solution of a high concentration, LiMn₂O₄ as the cathode active material, and Mo₆S₈ as the anode active material are combined, to form an aqueous lithium ion secondary battery.

### CITATION LIST

### Patent Literature

Patent Literature 1: JP 2009-259473 A
Patent Literature 2: JP 2012-009322 A

### Non Patent Literature

Non Patent Literature 1: Liumin Suo, et al., “Water-in-salt” electrolyte enables high-voltage aqueous lithium-ion chemistries, Science 350, 938 (2015)

### SUMMARY

### Technical Problem

While dissolution of the high concentration of LiTFSI expands a potential window of an aqueous electrolyte solution on the reduction side to approximately 1.9 V vs Li/Li+, it is difficult to use an anode active material to charge and discharge lithium ions at a potential baser than this. The aqueous lithium ion secondary battery of Non Patent Literature 1 still has restrictions on active materials etc. that can be used, has a low voltage, and also has a low discharge capacity, which are problematic.

### Solution to Problem

The present application discloses an aqueous electrolyte solution for a lithium ion secondary battery comprising: water; a lithium ion; a TFSI anion; and a cation that can form an ionic liquid when the cation forms a salt along with the TSFI anion in an atmospheric atmosphere, the cation being at least one selected from the group consisting of an ammonium cation, a piperidinium cation, a phosphonium cation, and an imidazolium cation, as one means for solving the above described problems.

“TFSI anion” is a bis(trifluoromethanesulfonyl)imide anion represented by the following formula (1).

A “cation that can form an ionic liquid when the cation forms a salt along with the TSFI anion in an atmospheric atmosphere” is a cation that can form an ionic liquid when bonding with a TFSI anion to form a salt in an atmospheric atmosphere (ambient temperature: 20° C., pressure: atmospheric pressure), independently from the aqueous electrolyte solution. This cation does not have to bond with a TFSI anion to form an ionic liquid when included in the aqueous electrolyte solution of the present disclosure.

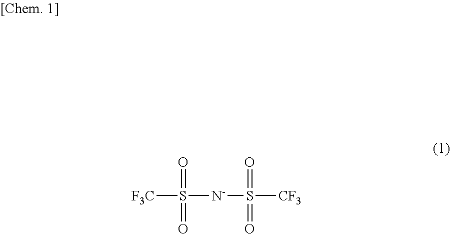 [SMILES: O=S(=O)([N-]S(=O)(=O)C(F)(F)F)C(F)(F)F]

In the aqueous electrolyte solution of this disclosure, no less than 1 mol of the lithium ions, and no less than 1 mol of the TFSI anions are preferably included per kilogram of the water.

The aqueous electrolyte solution of this disclosure preferably contains the imidazolium cation.

The present application discloses an aqueous lithium ion secondary battery comprising: a cathode; an anode; and the aqueous electrolyte solution of this disclosure, as one means for solving the above described problems.

In the aqueous lithium ion secondary battery of this disclosure, the anode preferably contains Li₄Ti₅O₁₂ as an anode active material.

The present application discloses a method for producing an aqueous electrolyte solution for a lithium ion secondary battery, the method comprising: mixing water, LiTFSI, and an ionic liquid, wherein the ionic liquid is a salt of a cation and a TFSI anion, the cation being at least one selected from the group consisting of an ammonium cation, a piperidinium cation, a phosphonium cation, and an imidazolium cation, as one means for solving the above described problems.

In the method for producing an aqueous electrolyte solution of this disclosure, the content of the LiTFSI is preferably no less than 1 mol per kilogram of the water.

In the method for producing an aqueous electrolyte solution of this disclosure, the ionic liquid is preferably a salt of the imidazolium cation and the TFSI anion.

The present application discloses a method for producing an aqueous lithium ion secondary battery, the method comprising: producing an aqueous electrolyte solution by the producing method of this disclosure; producing a cathode; producing an anode; and storing the aqueous electrolyte solution, the cathode, and the anode in a battery case, as one means for solving the above described problems.

In the method for producing an aqueous lithium ion secondary battery of this disclosure, Li₄Ti₅O₁₂ is preferably used as an anode active material in the anode.

### Advantageous Effects

One feature of the aqueous electrolyte solution of the present disclosure is including specific cations in addition to lithium ions and TFSI anions. It is predicted that according to such an aqueous electrolyte solution including specific cations, repellency of these specific cations suppresses adsorption of water to electrodes (especially anode), which suppresses reductive decomposition of the aqueous electrolyte solution in charge and discharge of the electrodes. It is also predicted that including these specific cations decreases unsolvated free water molecules, which suppresses reductive decomposition of the aqueous electrolyte solution. If the aqueous electrolyte solution of this disclosure is employed in an aqueous lithium ion secondary battery, an anode active material that is difficult to be employed in a conventional aqueous lithium ion secondary battery, such as Li₄Ti₅O₁₂ can be also employed, the battery voltage is high, and the discharge capacity is high.

### BRIEF DESCRIPTION OF DRAWINGS

FIG. 1 is an explanatory schematic view of an aqueous lithium ion secondary battery 1000;

FIG. 2 is an explanatory view of a flow of a method for producing an aqueous electrolyte solution 50:

FIG. 3 is an explanatory flowchart of a method for producing the aqueous lithium ion secondary battery 1000;

FIG. 4 shows charge-discharge curves according to Comparative Example 3;

FIG. 5 shows charge-discharge curves according to Example 3;

FIG. 6 shows charge-discharge curves according to Example 6;

FIG. 7 shows charge-discharge curves according to Example 9;

FIG. 8 shows charge-discharge curves according to Example 12; and

FIG. 9 shows charge-discharge curves according to Example 15.

### DETAILED DESCRIPTION OF EMBODIMENTS

1. Aqueous Electrolyte Solution

A feature of the aqueous electrolyte solution of this disclosure is an aqueous electrolyte solution used for a lithium ion secondary battery comprising: water; a lithium ion; a TFSI anion; and a cation that can form an ionic liquid when the cation forms a salt along with the TSFI anion in an atmospheric atmosphere, the cation being at least one selected from the group consisting of an ammonium cation, a piperidinium cation, a phosphonium cation, and an imidazolium cation.

1.1. Solvent

The aqueous electrolyte solution of this disclosure contains water as solvent. The solvent contains water as the main component except an ionic liquid described later. That is, no less than 50 mol %, preferably no less than 70 mol %, and more preferably no less than 90 mol % of the solvent that forms the electrolyte solution (liquid components except the ionic liquid) is water on the basis of the total amount of the solvent (100 mol %). In contrast, the upper limit of the proportion of water in the solvent is not specifically restricted.

The solvent may contain solvent other than water, in addition to water, in view of, for example, forming SEI (Solid Electrolyte Interphase) over surfaces of active materials. Examples of solvent except water include at least one organic solvent selected from ethers, carbonates, nitriles, alcohols, ketones, amines, amides, sulfur compounds, and hydrocarbons. Preferably no more than 50 mol %, more preferably no more than 30 mol %, and further preferably no more than 10 mol % of the solvent that forms the electrolyte solution (liquid components except the ionic liquid) is the solvent except water on the basis of the total amount of the solvent (100 mol %).

1.2. Electrolyte

The aqueous electrolyte solution of the present disclosure contains an electrolyte. Electrolytes usually dissolve in aqueous electrolyte solutions to dissociate into cations and anions.

1.2.1. Cations

The aqueous electrolyte solution of this disclosure essentially includes lithium ions as cations. Specifically, the aqueous electrolyte solution includes preferably no less than 1 mol, more preferably no less than 5 mol, further preferably no less than 7.5 mol, and especially preferably no less than 10 mol of lithium ions per kilogram of water. The upper limit thereof is not specifically restricted, and for example, is preferably no more than 25 mol. As the concentration of lithium ions is high along with TFSI anions described later, the potential window of the aqueous electrolyte solution on the reduction side tends to expand.

The aqueous electrolyte solution of this disclosure essentially includes the cation that can form an ionic liquid when the cation forms a salt along with the TSFI anion in an atmospheric atmosphere, the cation being at least one selected from the group consisting of an ammonium cation, a piperidinium cation, a phosphonium cation, and an imidazolium cation (may be referred to as “specific cations” in this application). It is predicted that including the specific cations in the aqueous electrolyte solution suppresses adsorption of water to electrodes (especially anode) according to repellency of the specific cations, which suppresses reductive decomposition of the aqueous electrolyte solution in charge and discharge of the electrodes. It is also predicted that including the specific cations decreases unsolvated free water molecules, which suppresses reductive decomposition of the aqueous electrolyte solution. If such an aqueous electrolyte solution is applied to a lithium ion secondary battery, an anode active material that is conventionally difficult to be employed can be employed, and the discharge capacity of the battery is high.

Specifically, the aqueous electrolyte solution of this disclosure preferably includes imidazolium cations among the specific cations. According to the findings of the inventors of the present application, when an aqueous electrolyte solution including imidazolium cations is applied as an electrolyte solution of a lithium ion secondary battery, the properties of the battery (discharge capacity, coulomb efficiency, capacity retention) are specifically excellent. It is predicted that imidazolium cations suppress reductive decomposition of the aqueous electrolyte solution by a mechanism different from the other specific cations. For example, imidazolium cations are easy to be reduced compared with the other specific cations. Thus, it is predicted that imidazolium cations reduce to decompose before lithium ions are inserted in an anode active material by charging, to form stable SEI on surfaces of active materials.

The aqueous electrolyte solution of this disclosure preferably includes 1 mol to 150 mol of the specific cations per kilogram of water. The lower limit thereof is more preferably no less than 3 mol, and further preferably no less than 10 mol; and the upper limit thereof is more preferably no more than 100 mol, and further preferably no more than 50 mol. Including even a slight amount of the specific cations in the aqueous electrolyte solution of this disclosure is believed to bring about a certain effect. In order to bring about a more pronounced effect, the content of the specific cations is preferably no less than a certain amount. In contrast, including a large amount of the specific cations in the aqueous electrolyte solution of this disclosure is also believed to bring about a certain effect. In view of advantages of the aqueous electrolyte solution (having a low viscosity, making it easy for lithium ions to move etc.), the content of the specific cations is preferably no more than a certain amount. In the aqueous electrolyte solution of this disclosure, the specific cations may be mixed with, and dissolved in water, or may phase separate from water. Particularly, the specific cations are preferably mixed with, and dissolved in water.

Specific examples of ammonium cations include butyltrimethylammonium cations, N,N-diethyl-N-methyl-N-(2-methoxyethyl)ammonium cations, tetrabutylammonium cations, tetramethylammonium cations, tributylmethylammonium cations, and methyltrioctylammonium cations.

Specific examples of piperidinium cations include N-methyl-N-propylpiperidinium cations, and 1-butyl-1-methylpiperidinium cations.

Specific examples of phosphonium cations include triethylpentylphosphonium cations.

Specific examples of imidazolium cations include 1-allyl-3-methylimidazolium cations, 1-allyl-3-ethylimidazolium cations, 1-allyl-3-butylimidazolium cations, 1,3-diallylimidazolium cations, and 1-methyl-3-propylimidazolium cations.

1.2.2. Anions

The aqueous electrolyte solution of this disclosure essentially includes TFSI anions as anions. Specifically, the aqueous electrolyte solution includes preferably no less than 1 mol, more preferably no less than 5 mol, further preferably no less than 7.5 mol, and especially preferably no less than 10 mol of TFSI anions per kilogram of water. The upper limit thereof is not specifically restricted, and for example, is preferably no more than 25 mol. As the concentration of TFSI anions is high along with the above described lithium ions, the potential window of the aqueous electrolyte solution on the reduction side tends to expand.

1.3. Other Components

The aqueous electrolyte solution of this disclosure may contain (an)other electrolyte(s). Examples thereof include imide-based electrolytes such as lithium bis(fluorosulfonyl)imide. LiPF₆, LiBF₄, Li₂SO₄, LiNO₃, etc. may be contained as well. Preferably no more than 50 mol %, more preferably no more than 30 mol %, and further preferably no more than 10 mol % of the electrolytes contained (dissolving) in the electrolyte solution is the other electrolyte(s) on the basis of the total amount of the electrolytes (100 mol %).

The aqueous electrolyte solution of this disclosure may contain (an)other component(s) in addition to the above described solvents and electrolytes. For example, alkali metal ions other than lithium ions, alkaline earth metal ions, etc. as cations can be also added as the other components. Further, hydroxides etc. may be contained for adjusting pH of the aqueous electrolyte solution.

pH of the aqueous electrolyte solution of this disclosure is not specifically restricted. There are general tendencies for a potential window on the oxidation side to expand as pH of an aqueous electrolyte solution is low, while for that on the reduction side to expand as pH thereof is high, to which the aqueous electrolyte solution including lithium ions and TSFI ions is not limited. That is, in the aqueous electrolyte solution of this disclosure, while higher concentrations of lithium ions and TFSI anions (can be referred to as a concentration of LiTFSI as well) lead to lower pH, the potential window on the reduction side can be sufficiently expanded even if a high concentration of LiTFSI is contained. For example, pH of the aqueous electrolyte solution of this disclosure is preferably 3 to 11 in view of the potential windows on the oxidation side and the reduction side. The lower limit of pH is more preferably no less than 6, and the upper limit thereof is more preferably no more than 8.

2. Aqueous Lithium Ion Secondary Battery

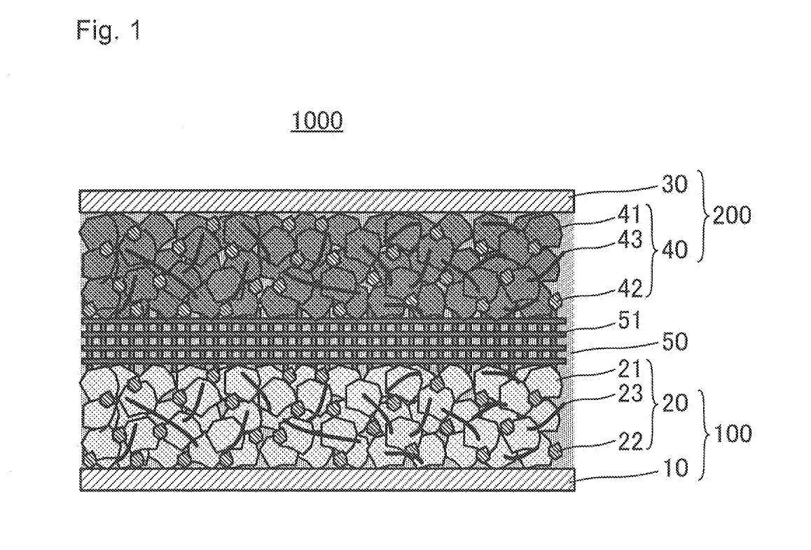

FIG. 1 schematically shows the structure of an aqueous lithium ion secondary battery 1000. As shown in FIG. 1, the aqueous lithium ion secondary battery 1000 includes a cathode 100, an anode 200, and an aqueous electrolyte solution 50. Here, one feature of the aqueous lithium ion secondary battery 1000 is including the aqueous electrolyte solution of this disclosure as the aqueous electrolyte solution 50.

2.1. Cathode

The cathode 100 includes a cathode current collector 10, and a cathode active material layer 20 including a cathode active material 21 and touching the cathode current collector 10.

2.1.1. Cathode Current Collector

A known metal that can be used as a cathode current collector of an aqueous lithium ion secondary battery can be used as the cathode current collector 10. Examples thereof include metallic material containing at least one element selected from the group consisting of Ni, Al, V, Au, Pt, Mg, Fe, Ti, Co, Cr, and Zn. The form of the cathode current collector 10 is not specifically restricted, and can be any form such as foil, mesh, and a porous form.

2.1.2. Cathode Active Material Layer

The cathode active material layer 20 includes the cathode active material 21. The cathode active material layer 20 may include a conductive additive 22, and a binder 23, in addition to the cathode active material 21.

Any cathode active material for an aqueous lithium ion secondary battery can be employed as the cathode active material 21. Needless to say, the cathode active material 21 has a potential higher than that of an anode active material 41 described later, and is properly selected in view of the above described potential window of the aqueous electrolyte solution 50. For example, a cathode active material containing a Li element is preferable. Specifically, an oxide, a polyanion, or the like containing a Li element is preferable, which is more specifically lithium cobaltate (LiCoO₂); lithium nickelate (LiNiO₂); lithium manganate (LiMn₂O₄); LiNi_{1/3}Mn_{1/3}InCo_{1/3}O₂; a different kind element substituent Li—Mn spinel represented by Li₁₊ₓMn_{2-x-y}M_{y}O₄ (M is at least one selected from Al, Mg, Co, Fe, Ni, and Zn); a lithium metal phosphate (LiMPO₄, M is at least one selected from Fe, Mn, Co, and Ni); or the like. Or, lithium titanate (LiₓTiO_{y}), TiO₂, LiTi₂(PO₄)₃, sulfur (S), or the like which shows a nobler charge-discharge potential compared to the anode active material described later can be used as well. Specifically, a cathode active material containing a Mn element in addition to a Li element is preferable, and a cathode active material of a spinel structure such as LiMn₂O₄ and Li₁₊ₓ+Mn_{2-x-y}Ni_{y}O₄ is more preferable. Since the oxidation potential of the potential window of the aqueous electrolyte solution 50 can be approximately no less than 5.0 V (vs. Li/Li⁺), a cathode active material of a high potential which contains a Mn element in addition to a Li element can be also used. One cathode active material may be used individually, or two or more cathode active materials may be mixed to be used as the cathode active material 21.

The shape of the cathode active material 21 is not specifically restricted. A preferred example thereof is a particulate shape. When the cathode active material 21 has a particulate shape, the primary particle size thereof is preferably 1 nm to 100 μm. The lower limit thereof is more preferably no less than 5 nm, further preferably no less than 10 nm, and especially preferably no less than 50 nm; and the upper limit thereof is more preferably no more than 30 μm, and further preferably no more than 10 μm. Primary particles of the cathode active material 21 one another may assemble to form a secondary particle. In this case, the secondary particle size is not specifically restricted, but is usually 0.5 μm to 50 μm. The lower limit thereof is preferably no less than 1 μm, and the upper limit thereof is preferably no more than 20 μm. The particle sizes of the cathode active material 21 within these ranges make it possible to obtain the cathode active material layer 20 further superior in ion conductivity and electron conductivity.

The amount of the cathode active material 21 included in the cathode active material layer 20 is not specifically restricted. For example, on the basis of the whole of the cathode active material layer 20 (100 mass %), the content of the cathode active material 21 is preferably no less than 20 mass %, more preferably no less than 40 mass %, further preferably no less than 60 mass %, and especially preferably no less than 70 mass %. The upper limit is not specifically restricted, but is preferably no more than 99 mass %, more preferably no more than 97 mass %, and further preferably no more than 95 mass %. The content of the cathode active material 21 within this range makes it possible to obtain the cathode active material layer 20 further superior in ion conductivity and electron conductivity.

The cathode active material layer 20 preferably includes the conductive additive 22, and the binder 23, in addition to the cathode active material 21. The types of the conductive additive 22 and the binder 23 are not specifically restricted.

Any conductive additive used in an aqueous lithium ion secondary battery can be employed as the conductive additive 22, which is specifically carbon material. Specifically, carbon material selected from Ketjen black (KB), vapor grown carbon fiber (VGCF), acetylene black (AB), carbon nanotubes (CNT), carbon nanofiber (CNF), carbon black, coke, and graphite is preferable. Or, metallic material that can bear an environment where the battery is to be used may be used. One conductive additive may be used individually, or two or more conductive additives may be mixed to be used as the conductive additive 22. Any form such as powder and fiber can be employed as the form of the conductive additive 22. The amount of the conductive additive 22 included in the cathode active material layer 20 is not specifically restricted. For example, the content of the conductive additive 22 is preferably no less than 0.1 mass %, more preferably no less than 0.5 mass %, and further preferably no less than 1 mass %, on the basis of the whole of the cathode active material layer 20 (100 mass %). The upper limit is not specifically restricted, but preferably no more than 50 mass %, more preferably no more than 30 mass %, and further preferably no more than 10 mass %. The content of the conductive additive 22 within this range makes it possible to obtain the cathode active material layer 20 further superior in ion conductivity and electron conductivity.

Any binder used for an aqueous lithium ion secondary battery can be employed as the binder 23. Examples thereof include styrene-butadiene rubber (SBR), carboxymethyl cellulose (CMC), acrylonitrile-butadiene rubber (ABR), butadiene rubber (BR), polyvinylidene fluoride (PVDF), and polytetrafluoroethylene (PTFE). One binder may be used individually, or two or more binders may be mixed to be used as the binder 23. The amount of the binder 23 included in the cathode active material layer 20 is not specifically restricted. For example, the content of the binder 23 is preferably no less than 0.1 mass %, more preferably no less than 0.5 mass %, and further preferably no less than 1 mass %, on the basis of the whole of the cathode active material layer 20 (100 mass %). The upper limit is not specifically restricted, but is preferably no more than 50 mass %, more preferably no more than 30 mass %, and further preferably no more than 10 mass %. The content of the binder 23 within this range makes it possible to properly bind the cathode active material 21 etc., and to obtain the cathode active material layer 20 further superior in ion conductivity and electron conductivity.

The thickness of the cathode active material layer 20 is not specifically restricted, but, for example, is preferably 0.1 μm to 1 mm, and more preferably 1 μm to 100 μm.

2.2. Anode

The anode 200 includes an anode current collector 30, and an anode active material layer 40 including the anode active material 41 and touching the anode current collector 30.

2.2.1. Anode Current Collector

A known metal that can be used as an anode current collector of an aqueous lithium ion secondary battery can be used as the anode current collector 30. Examples thereof include metallic material containing at least one element selected from the group consisting of Cu, Ni, Al, V, Au, Pt, Mg, Fe, Ti, Co, Cr, Zn, Ge, and In. Ti, Pb, Zn, Sn, Zr, and In are preferable in view of cycle stability as a secondary battery. Among them, Ti is preferable. The form of the anode current collector 30 is not specifically restricted, and can be any form such as foil, mesh, and a porous form.

2.2.2. Anode Active Material Layer

The anode active material layer 40 includes the anode active material 41. The anode active material layer 40 may include a conductive additive 42, and a binder 43, in addition to the anode active material 41.

The anode active material 41 may be selected in view of the potential window of the aqueous electrolyte solution. Examples thereof include lithium-transition metal complex oxides; titanium oxide; metallic sulfides such as Mo₆S₈ elemental sulfur; LiTi₂(PO₄)₃; NASICON; and carbon material. Specifically, a lithium-transition metal complex oxide is preferably contained, and lithium titanate is more preferably contained. Specifically, Li₄Ti₅O₁₂ (LTO) is especially preferably contained because good SEI tends to be formed. Charge and discharge of LTO in the aqueous solution, which is conventionally difficult, can be stably carried out in the aqueous lithium ion secondary battery 1000 as well.

The shape of the anode active material 41 is not specifically restricted. A preferred example thereof is a particulate shape. When the anode active material 41 has a particulate shape, the primary particle size thereof is preferably 1 nm to 100 μm. The lower limit thereof is more preferably no less than 10 nm, further preferably no less than 50 nm, and especially preferably no less than 100 nm; and the upper limit thereof is more preferably no more than 30 μm, and further preferably no more than 10 μm. Primary particles of the anode active material 41 one another may assemble to form a secondary particle. In this case, the secondary particle size is not specifically restricted, but is usually 0.5 μm to 100 μm. The lower limit thereof is preferably no less than 1 μm, and the upper limit thereof is preferably no more than 20 μm. The particle sizes of the anode active material 41 within these ranges make it possible to obtain the anode active material layer 40 further superior in ion conductivity and electron conductivity.

The amount of the anode active material 41 included in the anode active material layer 40 is not specifically restricted. For example, on the basis of the whole of the anode active material layer 40 (100 mass %), the content of the anode active material 41 is preferably no less than 20 mass %, more preferably no less than 40 mass %, further preferably no less than 60 mass %, and especially preferably no less than 70 mass %. The upper limit is not specifically restricted, but is preferably no more than 99 mass %, more preferably no more than 97 mass %, and further preferably no more than 95 mass %. The content of the anode active material 41 within this range makes it possible to obtain the anode active material layer 40 further superior in ion conductivity and electron conductivity.

The anode active material layer 40 preferably includes the conductive additive 42, and the binder 43, in addition to the anode active material 41. Types of the conductive additive 42 and the binder 43 are not specifically restricted. For example, the conductive additive 42 and the binder 43 can be properly selected to be used among the above described examples of the conductive additive 22 and the binder 23. The amount of the conductive additive 42 included in the anode active material layer 40 is not specifically restricted. For example, the content of the conductive additive 42 is preferably no less than 10 mass %, more preferably no less than 30 mass %, and further preferably no less than 50 mass %, on the basis of the whole of the anode active material layer 40 (100 mass %). The upper limit is not specifically restricted, but preferably no more than 90 mass %, more preferably no more than 70 mass %, and further preferably no more than 50 mass %. The content of the conductive additive 42 within this range makes it possible to obtain the anode active material layer 40 further superior in ion conductivity and electron conductivity. The amount of the binder 43 included in the anode active material layer 40 is not specifically restricted. For example, the content of the binder 43 is preferably no less than 1 mass %, more preferably no less than 3 mass %, and further preferably no less than 5 mass %, on the basis of the whole of the anode active material layer 40 (100 mass %). The upper limit is not specifically restricted, but is preferably no more than 90 mass %, more preferably no more than 70 mass %, and further preferably no more than 50 mass %. The content of the binder 43 within this range makes it possible to properly bind the anode active material 41 etc., and to obtain the anode active material layer 40 further superior in ion conductivity and electron conductivity.

The thickness of the anode active material layer 40 is not specifically restricted, but, for example, is preferably 0.1 μm to 1 mm, and more preferably 1 μm to 100 μm.

2.3. Aqueous Electrolyte Solution

An electrolyte solution exists inside an anode active material layer, inside a cathode active material layer, and between the anode and cathode active material layers in a lithium ion secondary battery of an electrolyte solution system, which secures lithium ion conductivity between the anode and cathode active material layers. This manner is also employed as the battery 1000. Specifically, in the battery 1000, a separator 51 is provided between the cathode active material layer 20 and the anode active material layer 40. The separator 51, the cathode active material layer 20, and the anode active material layer 40 are immersed in the aqueous electrolyte solution 50. The aqueous electrolyte solution 50 penetrates inside the cathode active material layer 20 and the anode active material layer 40.

The aqueous electrolyte solution 50 is the above described aqueous electrolyte solution of this disclosure. Detailed description thereof is omitted here.

2.4. Other Components

The separator 51 is provided between the cathode active material layer 20 and the anode active material layer 40 in the aqueous lithium ion secondary battery 1000. A separator used in a conventional aqueous electrolyte solution battery (NiMH. Zn-Air battery, etc.) is preferably employed as the separator 51. For example, a hydrophilic separator such as nonwoven fabric made of cellulose can be preferably used. The thickness of the separator 51 is not specifically restricted. For example, a separator of 5 μm to 1 mm in thickness can be used.

The aqueous lithium ion secondary battery 1000 is equipped with terminals, a battery case, etc., in addition to the above described structure. The other components are obvious for the skilled person who referred to the present application, and thus description thereof is omitted here.

### 3. Method for Producing Aqueous Electrolyte Solution

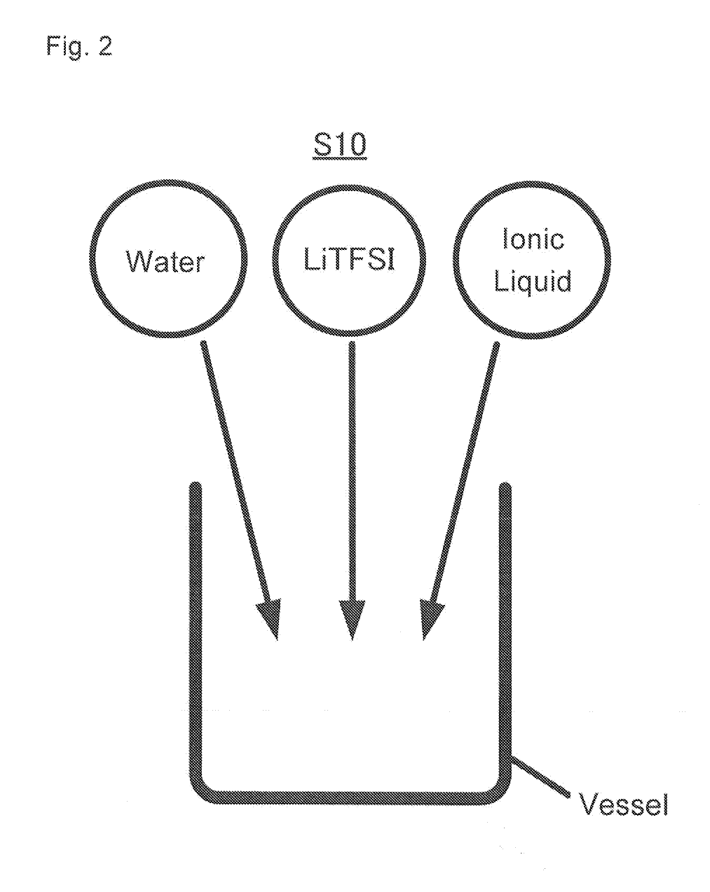

FIG. 2 shows a flow of a method for producing the aqueous electrolyte solution 50 S10. As shown in FIG. 2, the producing method S10 includes a step of mixing water, LiTFSI, and the ionic liquid. Here, it is important that in the producing method S10, the ionic liquid is a salt of a cation and a TFSI anion, the cation being at least one selected from the group consisting of an ammonium cation, a piperidinium cation, a phosphonium cation, and an imidazolium cation (above described “specific cations”). Among them, the ionic liquid is preferably salts of imidazolium cations and TFSI anions.

In the producing method S10, the means for mixing water, LiTFSI, and the ionic liquid is not specifically restricted. A known mixing means can be employed. The order of mixing water, LiTFSI, and the ionic liquid is not specifically restricted as well. As shown in FIG. 2, just a vessel is filled with water, LiTFSI, and the ionic liquid to allow them to stand, they mix, and finally the aqueous electrolyte solution 50 is obtained. According to the findings of the inventors of the present application, when water, LiTFSI, and the ionic liquid are mixed, a water phase and an ionic liquid phase might be separated just after the mixing, but the water phase and the ionic liquid phase mix as time passes, and an approximately uniform solution can be achieved.

In the producing method S10, one may prepare a solution (A) obtained by dissolving LiTFSI in water, and a solution (B) obtained by dissolving LiTFSI in the ionic liquid, and mix these solutions (A) and (B), to obtain the aqueous electrolyte solution 50.

In the producing method S10, the volume ratio of the water and the ionic liquid is not specifically restricted. The volume ratio can be preferably determined in view of the potential window, viscosity, etc. of the aqueous electrolyte solution. For example, the volume of the ionic liquid is preferably 0.1 to 10 times as large as that of water. The lower limit is more preferably no less than 0.3 times, and the upper limit is more preferably no more than 3 times.

In the producing method S10, the concentrations of LiTFSI and the ionic liquid in the aqueous electrolyte solution 50 are not specifically restricted. The concentrations thereof are preferably adjusted so that the concentrations of lithium ions, TFSI anions, and the specific cations in the aqueous electrolyte solution 50 are within the above described preferred ranges. For example, no less than 1 mol of LiTFSI is preferably contained per kilogram of water.

### 4. Method for Producing Aqueous Lithium Ion Secondary Battery

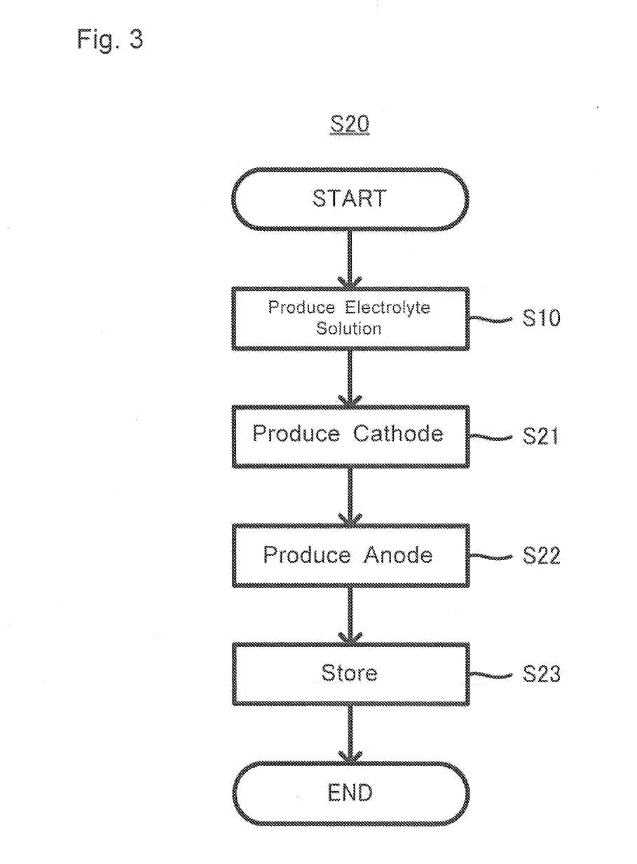

FIG. 3 is a flowchart of a method for producing the aqueous lithium ion secondary battery 1000 S20. As shown in FIG. 3, the producing method S20 includes the steps of producing the aqueous electrolyte solution 50 according to the producing method S10, producing the cathode 100 S21, producing the anode 200 S22, and storing the produced aqueous electrolyte solution 50, cathode 100, and anode 200 in the battery case S23. Needless to say, the order of the steps S10, S21, and S22 is not specifically restricted in the producing method S20.

4.1. Producing Aqueous Electrolyte Solution

The method for producing the aqueous electrolyte solution 50 is as described above. Detailed description thereof is omitted here.

4.2. Producing Cathode

The step of producing the cathode S21 may be the same as known steps. For example, the cathode active material etc. to form the cathode active material layer 20 is dispersed in solvent, to obtain a cathode mixture paste (slurry). Water and various organic solvents can be used as the solvent used in this case without specific restrictions. A surface of the cathode current collector 10 is coated with the cathode mixture paste (slurry) using a doctor blade or the like, and thereafter dried, to form the cathode active material layer 20 over the surface of the cathode current collector 10, to be the cathode 100. Electrostatic spray deposition, dip coating, spray coating, or the like can be employed as well, as the coating method, other than a doctor blade method.

4.3. Producing Anode

The step of producing the anode S22 may be the same as known steps. For example, the anode active material etc. to form the anode active material layer 40 is dispersed in solvent, to obtain an anode mixture paste (slurry). Water and various organic solvents can be used as the solvent used in this case without specific restrictions. A surface of the anode current collector 30 is coated with the anode mixture paste (slurry) using a doctor blade or the like, and thereafter dried, to form the anode active material layer 40 over the surface of the anode current collector 30, to be the anode 200. Electrostatic spray deposition, dip coating, spray coating, or the like can be employed as well, as the coating method, other than a doctor blade method.

4.4. Storing in Battery Case

The produced aqueous electrolyte solution 50, cathode 100, and anode 200 are stored in the battery case, to be the aqueous lithium ion secondary battery 1000. For example, the separator 51 is sandwiched between the cathode 100 and the anode 200, to obtain a stack including the cathode current collector 10, the cathode active material layer 20, the separator 51, the anode active material layer 40, and the anode current collector 30 in this order. The stack is equipped with other members such as terminals if necessary. The stack is stored in the battery case, and the battery case is filled with the aqueous electrolyte solution 50. The battery case which the stack is stored in and is filled with the electrolyte solution is sealed up such that the stack is immersed in the aqueous electrolyte solution 50, to be the aqueous lithium ion secondary battery 1000.

### EXAMPLES

1. Producing Aqueous Electrolyte Solution

### Comparative Example 1

Per kilogram of pure water, 5 mol of LiTFSI was dissolved, to obtain an aqueous electrolyte solution of Comparative Example 1.

### Comparative Example 2

Per kilogram of pure water, 10 mol of LiTFSI was dissolved, to obtain an aqueous electrolyte solution of Comparative Example 2.

### Comparative Example 3

Per kilogram of pure water, 21 mol of LiTFSI was dissolved, to obtain an aqueous electrolyte solution of Comparative Example 3.

### Example 1

Per kilogram of pure water, 5 mol of LiTFSI was dissolved, to be a solution (A1).

Per kilogram of an ionic liquid represented by the following formula (2) (butyltrimethylammonium bis(trifluoromethanesulfonyl)imide, BTMA-TFSI), 1 mol of LiTFSI was dissolved, to be a solution (B1).

The solutions (A1) and (B1) were mixed so as to have a volume ratio of 1:1, to obtain an aqueous electrolyte solution of Example 1.

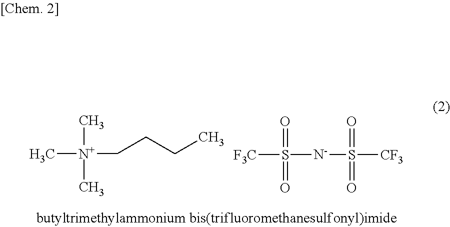

### Example 2

Per kilogram of pure water, 10 mol of LiTFSI was dissolved, to be a solution (A2).

Per kilogram of the ionic liquid represented by the formula (2), 1 mol of LiTFSI was dissolved, to be a solution (B2).

The solutions (A2) and (B2) were mixed so as to have a volume ratio of 1:1, to obtain an aqueous electrolyte solution of Example 2.

### Example 3

Per kilogram of pure water, 21 mol of LiTFSI was dissolved, to be a solution (A3).

Per kilogram of the ionic liquid represented by the formula (2), 1 mol of LiTFSI was dissolved, to be a solution (B3).

The solutions (A3) and (B3) were mixed so as to have a volume ratio of 1:1, to obtain an aqueous electrolyte solution of Example 3.

### Example 4

Per kilogram of pure water, 5 mol of LiTFSI was dissolved, to be a solution (A4).

Per kilogram of an ionic liquid represented by the following formula (3) (N,N-diethyl-N-methyl-N-(2-methoxyethyl)ammonium bis(trifluoromethanesulfonyl)imide. DEME-TFSI), 1 mol of LiTFSI was dissolved, to be a solution (B4).

The solutions (A4) and (B4) were mixed so as to have a volume ratio of 1:1, to obtain an aqueous electrolyte solution of Example 4.

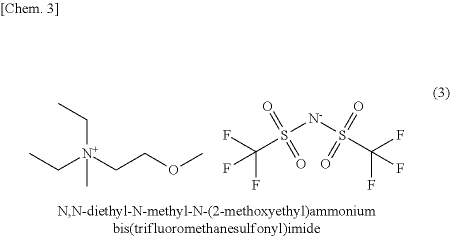

### Example 5

Per kilogram of pure water, 10 mol of LiTFSI was dissolved, to be a solution (A5).

Per kilogram of the ionic liquid represented by the formula (3), 1 mol of LiTFSI was dissolved, to be a solution (B5).

The solutions (A5) and (B5) were mixed so as to have a volume ratio of 1:1, to obtain an aqueous electrolyte solution of Example 5.

### Example 6

Per kilogram of pure water, 21 mol of LiTFSI was dissolved, to be a solution (A6).

Per kilogram of the ionic liquid represented by the formula (3), 1 mol of LiTFSI was dissolved, to be a solution (B6).

The solutions (A6) and (B6) were mixed so as to have a volume ratio of 1:1, to obtain an aqueous electrolyte solution of Example 6.

### Example 7

Per kilogram of pure water, 5 mol of LiTFSI was dissolved, to be a solution (A7).

Per kilogram of an ionic liquid represented by the following formula (4) (N-methyl-N-propylpiperidinium bis(trifluoromethanesulfonyl)imide, PP13-TFSI), 1 mol of LiTFSI was dissolved, to be a solution (B7).

The solutions (A7) and (B7) were mixed so as to have a volume ratio of 1:1, to obtain an aqueous electrolyte solution of Example 7.

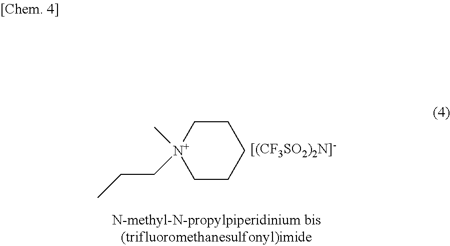

### Example 8

Per kilogram of pure water, 10 mol of LiTFSI was dissolved, to be a solution (A8).

Per kilogram of the ionic liquid represented by the formula (4), 1 mol of LiTFSI was dissolved, to be a solution (B8).

The solutions (A8) and (B8) were mixed so as to have a volume ratio of 1:1, to obtain an aqueous electrolyte solution of Example 8.

### Example 9

Per kilogram of pure water, 21 mol of LiTFSI was dissolved, to be a solution (A9).

Per kilogram of the ionic liquid represented by the formula (4), 1 mol of LiTFSI was dissolved, to be a solution (B9).

The solutions (A9) and (B9) were mixed so as to have a volume ratio of 1:1, to obtain an aqueous electrolyte solution of Example 9.

### Example 10

Per kilogram of pure water, 5 mol of LiTFSI was dissolved, to be a solution (A10).

Per kilogram of an ionic liquid represented by the following formula (5) (triethylpentylphosphonium bis(trifluoromethanesulfonyl)imide, P2225-TFSI), 1 mol of LiTFSI was dissolved, to be a solution (B10).

The solutions (A10) and (B10) were mixed so as to have a volume ratio of 1:1, to obtain an aqueous electrolyte solution of Example 10.

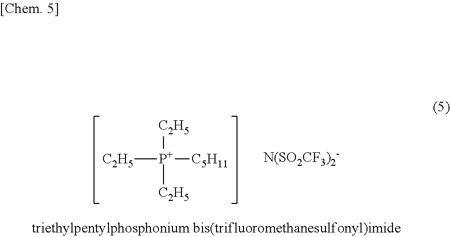

### Example 11

Per kilogram of pure water, 10 mol of LiTFSI was dissolved, to be a solution (A11).

Per kilogram of the ionic liquid represented by the formula (5), 1 mol of LiTFSI was dissolved, to be a solution (B11).

The solutions (A11) and (B11) were mixed so as to have a volume ratio of 1:1, to obtain an aqueous electrolyte solution of Example 11.

### Example 12

Per kilogram of pure water, 21 mol of LiTFSI was dissolved, to be a solution (A12).

Per kilogram of the ionic liquid represented by the formula (5), 1 mol of LiTFSI was dissolved, to be a solution (B12).

The solutions (A12) and (B12) were mixed so as to have a volume ratio of 1:1, to obtain an aqueous electrolyte solution of Example 12.

### Example 13

Per kilogram of pure water, 5 mol of LiTFSI was dissolved, to be a solution (A13).

Per kilogram of an ionic liquid represented by the following formula (6) (1-allyl-3-methylimidazolium bis(trifluoromethanesulfonyl)imide, AMIm-TFSI), 1 mol of LiTFSI was dissolved, to be a solution (B13).

The solutions (A13) and (B13) were mixed so as to have a volume ratio of 1:1, to obtain an aqueous electrolyte solution of Example 13.

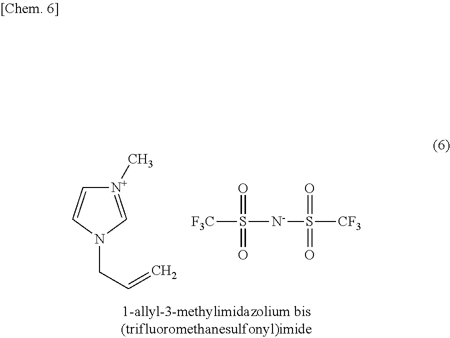

### Example 14

Per kilogram of pure water, 10 mol of LiTFSI was dissolved, to be a solution (A14).

Per kilogram of the ionic liquid represented by the formula (6), 1 mol of LiTFSI was dissolved, to be a solution (B14).

The solutions (A14) and (B14) were mixed so as to have a volume ratio of 1:1, to obtain an aqueous electrolyte solution of Example 14.

### Example 15

Per kilogram of pure water, 21 mol of LiTFSI was dissolved, to be a solution (A15).

Per kilogram of the ionic liquid represented by the formula (6), 1 mol of LiTFSI was dissolved, to be a solution (B15).

The solutions (A15) and (B15) were mixed so as to have a volume ratio of 1:1, to obtain an aqueous electrolyte solution of Example 15.

2. Producing Electrodes

As the cathode active material, LiFePO₄ was prepared. LiFePO₄ has a flat redox potential of 3.5 V vs Li/Li+, and thus was used as a reference potential.

As the anode active material, Li₄Ti₅O₁₂ was prepared.

As the conductive additive, acetylene black was prepared.

As the binder, PVdF was prepared.

The cathode active material, the conductive additive, and the binder were mixed, to form a cathode active material layer of 15 μm in thickness over Ti foil (cathode current collector). The composition ratio of the cathode active material layer was: cathode active material:conductive additive:binder=85:10:5 in terms of the mass ratio.

The anode active material, the conductive additive, and the binder were mixed, to form an anode active material layer of 15 μm in thickness over Ti foil (anode current collector). The composition ratio of the anode active material layer was: anode active material:conductive additive:binder=85:10:5 in terms of the mass ratio.

The weights of the electrodes were: cathode: 15 mg/cm² (76 μmt); anode: 10 mg/cm² (53 μmt).

3. Producing Aqueous Lithium Ion Secondary Battery

The produced aqueous electrolyte solution, cathode, and anode were used to be a coin cell (coin cell, CR2032), to obtain an aqueous lithium ion secondary battery for evaluation.

4. Evaluation of Performance of Battery

4.1. Discharge Capacity (mAh/g)

The initial discharge capacity when charge and discharge were carried out at 0.1 C in current value at 25° C. in environmental temperature was measured.

4.2. Coulomb Efficiency (%)

The ratio of the initial charge capacity to the initial discharge capacity when charge and discharge were carried out at 0.1 C in current value at 25° C. in environmental temperature was determined to be the coulomb efficiency.

4.3. Capacity Retention (%)

The ratio of the discharge capacity at the third cycle to the initial discharge capacity when charge and discharge were carried out at 0.1 C in current value at 25° C. in environmental temperature was determined to be the capacity retention.

4.4. Self Discharge Rate (%)

The ratio of the discharge capacity after retention in the charged state for 20 hours, to the charge capacity when charge was carried out at 0.1 C in current value at 25° C. in environmental temperature was determined to be the self discharge rate.

4.5. Hysteresis (mV)

The difference between the average charging voltage and the average discharging voltage when charge and discharge were carried out at 0.1 C in current value at 25° C. in environmental temperature was determined to be the hysteresis.

5. Results of Evaluation

The results of the evaluation are shown in the following Table 1.

TABLE 11

| | | LiTFSI | | | | | |
|---|---|---|---|---|---|---|---|
| | | Concen- | | | | | |
| | | tration | | | | | |
| | | in | Dis- | | | | |
| | | So- | charge | Cou | Ca- | Self | |
| | | lution | Ca- | lomb | pacity | Dis- | Hys- |
| | | (A) | pacity | Effi- | Re- | charge | ter- |
| | Ionic | (mol/ | (mAh/ | ciency | tention | Rate | esis |
| | Liquid | kg) | g) | (%) | (%) | (%) | (mV) |
| Comp. | — | 5 | — | — | — | — | — |
| Ex. 1 | | | | | | | |
| Comp. | — | 10 | — | — | — | — | — |
| Ex. 2 | | | | | | | |
| Comp. | — | 21 | 15 | 16 | 27 | 0 | 390 |
| Ex. 3 | | | | | | | |
| Ex. 1 | BTMA- | 5 | 9 | 5 | 20 | 0 | 187 |
| Ex. 2 | TFSI | 10 | 33 | 13 | 11 | 2 | 163 |
| Ex. 3 | | 21 | 102 | 58 | 75 | 65 | 157 |
| Ex. 4 | DEME- | 5 | 8 | 5 | 11 | 0 | 190 |
| Ex. 5 | TFSI | 10 | 32 | 20 | 48 | 5 | 175 |
| Ex. 6 | | 21 | 113 | 65 | 85 | 58 | 160 |
| Ex. 7 | PP13- | 5 | 2 | 3 | 8 | 0 | 210 |
| Ex. 8 | TFSI | 10 | 35 | 21 | 36 | 6 | 153 |
| Ex. 9 | | 21 | 110 | 63 | 86 | 69 | 125 |
| Ex. 10 | P2225- | 5 | 8 | 6 | 21 | 0 | 209 |
| Ex. 11 | TFSI | 10 | 39 | 22 | 46 | 2 | 162 |
| Ex. 12 | | 21 | 117 | 67 | 88 | 70 | 132 |
| Ex. 13 | AMIm- | 5 | 12 | 7 | 42 | 0 | 98 |
| Ex. 14 | TFSI | 10 | 46 | 26 | 65 | 7 | 86 |
| Ex. 15 | | 21 | 143 | 82 | 89 | 75 | 65 |

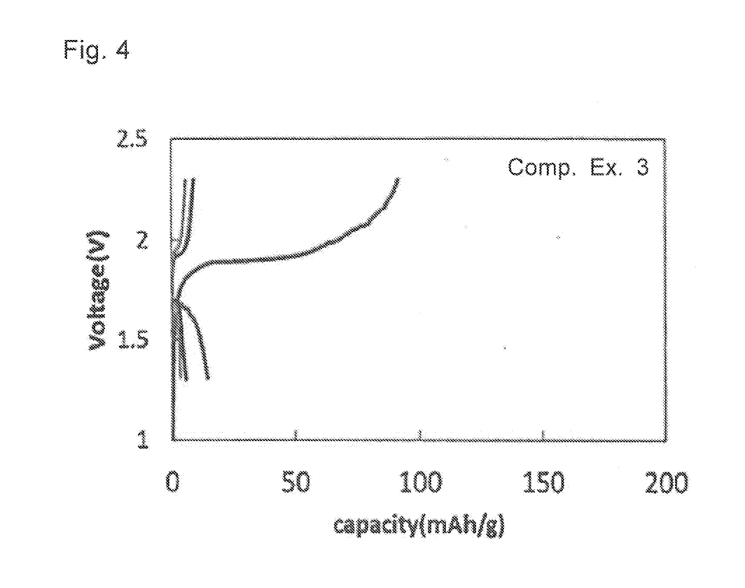

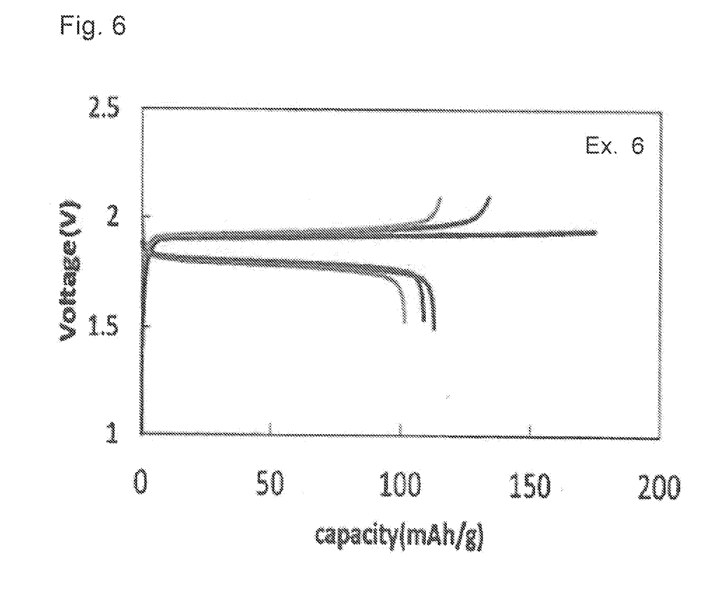

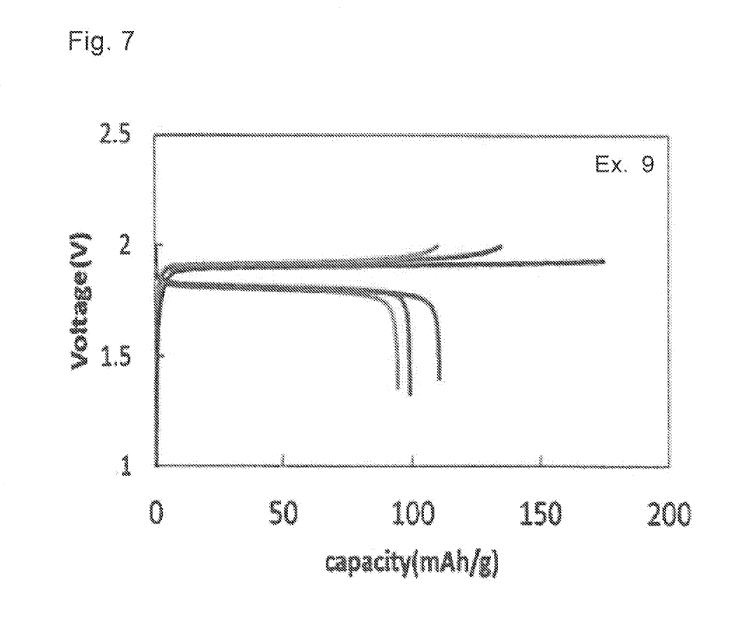

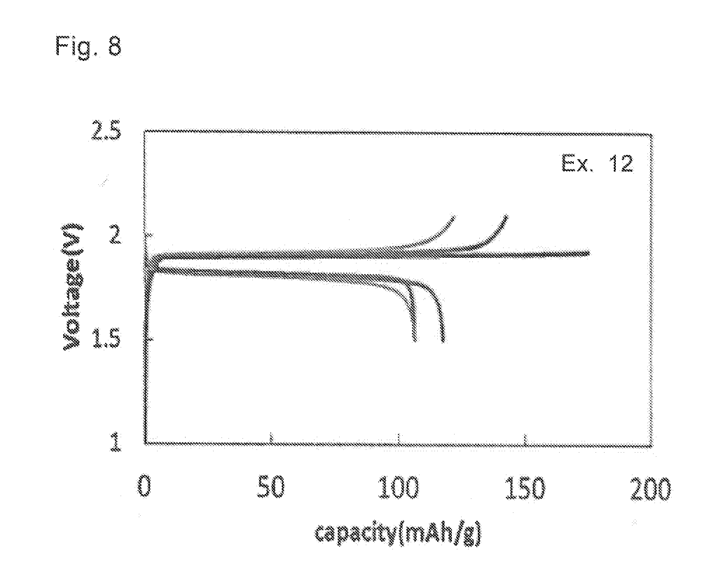

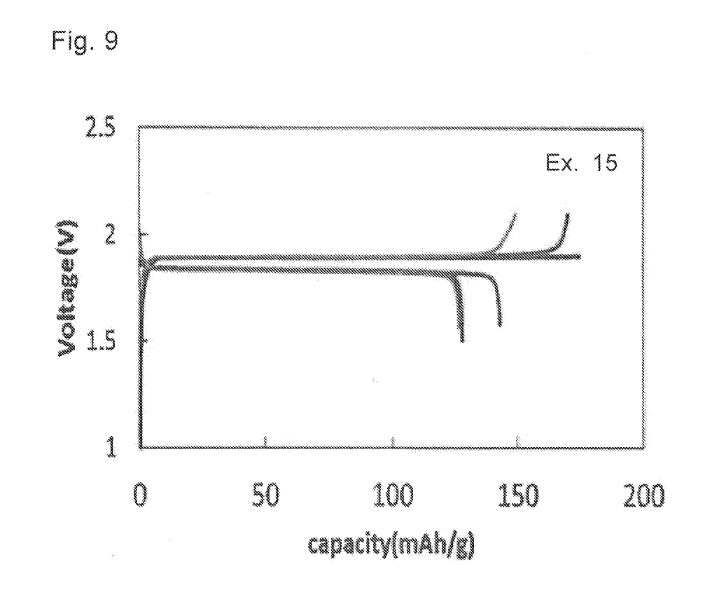

FIGS. 4 to 9 show charge-discharge curves of the aqueous lithium ion secondary batteries when the batteries were configured using the aqueous electrolyte solutions of Comparative Example 3, and Examples 3, 6, 9, 12 and 15, for reference.

As is clear from the results shown in Table 1 and FIG. 4, when the aqueous electrolyte solutions of Comparative Examples 1 and 2 were used, using Li₄Ti₅O₁₂ as the anode active material made it impossible to charge and discharge the aqueous lithium ion secondary batteries. On the other hand, a high concentration of LiTFSI in the aqueous electrolyte solution as Comparative Example 3 made it possible to slightly charge and discharge the aqueous lithium ion secondary battery.

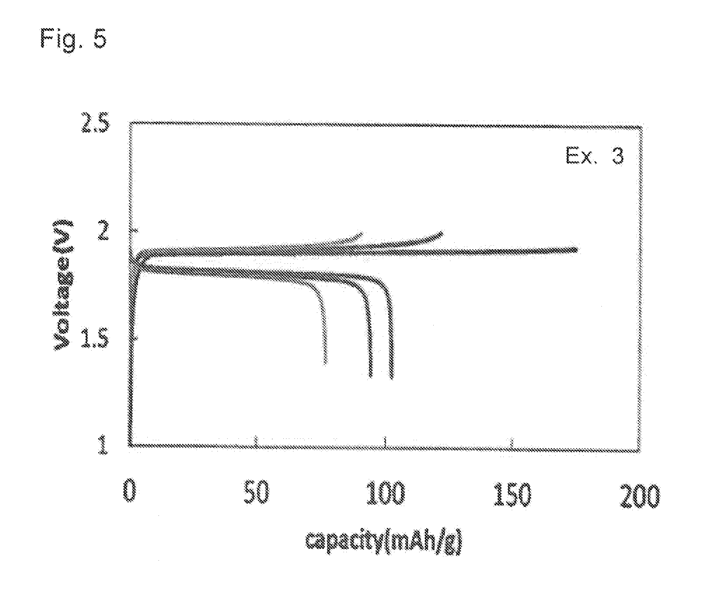

In contrast, as is clear from the results shown in Table 1 and FIGS. 5 to 9, when predetermined cations (cations derived from the ionic liquids) were composited in the aqueous electrolyte solutions (Examples 1 to 15), the aqueous lithium ion secondary batteries were able to be charged and discharged even if the LiTFSI concentrations in the solutions (A) of the aqueous electrolyte solutions were as low as 5 mol/kg and 10 mol/kg. When the LiTFSI concentration in the solutions (A) in the aqueous electrolyte solutions was as high as 21 mol/kg, the properties of the batteries were dramatically improved whatever cations were composited. The reason why the properties of the batteries were improved is uncertain, but it is predicted that repellency of specific cations suppressed adsorption of water to the anodes, which suppressed reductive decomposition of water. It is also predicted that compositing specific cations decreased unsolvated free water molecules in the aqueous electrolyte solutions, which suppressed reductive decomposition of water.

Specifically, excellent properties of the batteries were achieved when imidazolium cations were composited as Examples 13 to 15. The reason why imidazolium cations dramatically brought about the effect is uncertain, but it is predicted that imidazolium cations suppress decomposition of water by a mechanism different from the other specific cations. Alternatively, imidazolium cations are believed to be easy to be reduced compared with the other specific cations. Therefore, it is predicted that imidazolium cations reduced to decompose before lithium ions were inserted in the anode active materials by charging, to form stable SEI.

As described above, it was found that in the aqueous electrolyte solution including water, lithium ions, and TFSI anions, further compositing a cation that can form an ionic liquid when the cation forms a salt along with the TSFI anion in an atmospheric atmosphere, the cation being at least one selected from the group consisting of an ammonium cation, a piperidinium cation, a phosphonium cation, and an imidazolium cation suppressed reductive decomposition of water in charge and discharge of the aqueous lithium ion secondary battery, to secure excellent properties of the battery.

As the anode active material, Li₄Ti₅O₁₂ was used in the Examples. The anode active material is not limited to this. For example, when titanium oxide (TiO₂) is used as the anode active material, the anode can be charged and discharged under milder conditions and it is harder for water to reduce to decompose than the case of using Li₄Ti₅O₁₂ as the anode active material. That is, it is believed that even if the LiTFSI concentration in the solution (A) is lower than 5 mol/kg, compositing the above described specific cations makes it possible to perform charge and discharge as an aqueous lithium ion secondary battery, employing any anode active material. As described above, the concentrations of lithium ions and TFSI anions in the aqueous electrolyte solution can be properly changed according to the type of the anode active material, and the concentration of specific cations to be composited. For example, even if the concentrations of lithium ions and TFSI anions in the aqueous electrolyte solution are 1 mol/kg, the effect by compositing specific cations is brought about, which makes it possible to perform charge and discharge as a lithium ion secondary battery according to the type of the anode active material.

As the cathode active material, LiFePO₄ was used in the Examples. The cathode active material is not limited to this. The cathode active material may be properly determined according to the potential window of the aqueous electrolyte solution on the oxidation side etc.

### INDUSTRIAL APPLICABILITY

The aqueous lithium ion secondary battery using the aqueous electrolyte solution of this disclosure has a high discharge capacity, and can be used in a wide range of power sources such as an onboard large-sized power source, and a small-sized power source for portable terminals.

### REFERENCE SIGNS LIST

10 cathode current collector
20 cathode active material layer
   21 cathode active material
   22 conductive additive
   23 binder
30 anode current collector
40 anode active material layer
   41 anode active material
   42 conductive additive
   43 binder
50 aqueous electrolyte solution
51 separator
100 cathode
200 anode
1000 aqueous lithium ion secondary battery

What is claimed is:

1. An aqueous electrolyte solution for a lithium ion secondary battery comprising:
water;
a lithium ion;
a TFSI anion; and
a cation that can form an ionic liquid when the cation forms a salt along with the TSFI anion in an atmospheric atmosphere, the cation being at least one selected from the group consisting of an ammonium cation, a piperidinium cation, a phosphonium cation, and an imidazolium cation.

2. The aqueous electrolyte solution according to claim 1, wherein
no less than 1 mol of the lithium ions, and no less than 1 mol of the TFSI anions are included per kilogram of the water.

3. The aqueous electrolyte solution according to claim 1, wherein the cation is at least the imidazolium cation.

4. An aqueous lithium ion secondary battery comprising:
a cathode;
an anode; and
the aqueous electrolyte solution according to claim 1.

5. The aqueous lithium ion secondary battery according to claim 4, wherein the anode contains Li₄Ti₅O₁₂ as an anode active material.

6. A method for producing an aqueous electrolyte solution for a lithium ion secondary battery, the method comprising:
mixing water, LiTFSI, and an ionic liquid,
wherein the ionic liquid is a salt of a cation and a TFSI anion, the cation being at least one selected from the group consisting of an ammonium cation, a piperidinium cation, a phosphonium cation, and an imidazolium cation.

7. The method according to claim 6, wherein the content of the LiTFSI is no less than 1 mol per kilogram of the water.

8. The method according to claim 6, wherein the ionic liquid is a salt of the imidazolium cation and the TFSI anion.

9. A method for producing an aqueous lithium ion secondary battery, the method comprising:
producing an aqueous electrolyte solution by the method according to of claim 6;
producing a cathode;
producing an anode; and
storing the aqueous electrolyte solution, the cathode, and the anode in a battery case.

10. The method according to claim 9, wherein Li₄Ti₅O₁₂ is used as an anode active material in the anode.
